(19) United States
(12) Patent Application Publication
(10) Pub. No.: US 2025/0336410 A1
(43) Pub. Date: Oct. 30, 2025

(54) ELECTRONIC DEVICE AND METHOD FOR OPTIMIZING INPUT AUDIO

(71) Applicant: SAMSUNG ELECTRONICS CO., LTD., Suwon-si (KR)

(72) Inventors: Dewanshu HASWANI, Bengaluru (IN); Abhiram R, Bengaluru (IN); Pushkaraj Vinayak SHIRVALKAR, Bengaluru (IN); Vijay Narayan TIWARI, Bengaluru (IN)

(73) Assignee: SAMSUNG ELECTRONICS CO., LTD., Suwon-si (KR)

(21) Appl. No.: 19/217,330

(22) Filed: May 23, 2025

Related U.S. Application Data
(63) Continuation of application No. PCT/IB2025/054376, filed on Apr. 28, 2025.

(30) Foreign Application Priority Data
Apr. 30, 2024 (IN) 202441034170
Jan. 31, 2025 (IN) 202441034170

(51) Int. Cl. G10L 25/27; G10L 25/06; G10L 25/24

(52) U.S. Cl. CPC G10L 25/27; G10L 25/06; G10L 25/24

(57) ABSTRACT

A method for optimizing an input audio includes receiving the input audio from an audio source in an environment, the input audio having been reflected from a surface in the environment, processing the input audio using an artificial intelligence (AI) model, estimating, using the AI model, a correction value to be applied to the input audio for each range of a plurality of spatial ranges in the environment, and optimizing the at least one audio feature for a spatial range of the plurality of spatial ranges by applying the correction value to the input audio. The AI model having been pre-trained with a correlation between ultra-wideband (UWB) spatial data of a plurality of surfaces in the environment and a plurality of audio features including at least one of an amplitude, a frequency, or a spectrogram corresponding to the environment.

### CROSS-REFERENCE TO RELATED APPLICATIONS

This application is a continuation application of International Application No. PCT/IB2025/054376, filed on Apr. 28, 2025, which claims priority to Indian Provisional Patent Application No. 202441034170, filed on Apr. 30, 2024, and Indian Complete patent application Ser. No. 202441034170, filed on Jan. 31, 2025, in the Intellectual Property India Office, the disclosures of which are incorporated by reference herein in their entireties.

### BACKGROUND

### 1. Field

The present disclosure relates to generally audio modification and more particularly, to an electronic device and a method for optimizing input audio.

### 2. Description of Related Art

Audio units, which may be referred to as speakers, may be employed to produce sound. Further, based on an area in which the sound is produced, a number of speakers may be installed in the area. For example, in an indoor setup such as, but not limited to, a home cinema, speakers may be placed at different regions to produce surround sound. In another example, in an outdoor setup, such as, but not limited to, a concert, a number of speakers may be arranged at different locations. Generally, the sound may be reflected by surfaces in the region, such as, but not limited to, walls, floor, or a ceiling, and as a result of the reflection, characteristics of the sound may change. The change in the sound characteristics may change the audio experience of the user.

Attempts to address and/or mitigate this issue may include to tune the audio units. Related attempts may rely on manual adjustments of audio units by skilled professionals, which may be time-consuming and/or labor-intensive. Alternatively, other attempts may rely on fixed preset configurations that may be based on user input. However, such attempts may struggle to adapt to the dynamic nature of indoor and/or outdoor environments, which may lead to suboptimal sound quality under varying conditions.

Therefore, in view of the above-mentioned problems, it may be advantageous to provide an improved system and method that address the above-mentioned problems and limitations associated with the related tuning techniques.

### SUMMARY

This summary is provided to introduce a selection of concepts, in a simplified format, that are further described in the detailed description of the present disclosure. This summary is neither intended to identify key or essential concepts of the disclosure nor is it intended for determining the scope of the disclosure.

According to an aspect of the present disclosure, a method for optimizing an input audio includes receiving the input audio from an audio source in an environment, the input audio having been reflected from a surface in the environment, processing the input audio using an artificial intelligence (AI) model, estimating, using the AI model, a correction value to be applied to the input audio for each range of a plurality of spatial ranges in the environment, and optimizing the at least one audio feature for a spatial range of the plurality of spatial ranges by applying the correction value to the input audio. The AI model having been pre-trained with a correlation between ultra-wideband (UWB) spatial data of a plurality of surfaces in the environment and a plurality of audio features including at least one of an amplitude, a frequency, or a spectrogram corresponding to the environment. The correction value being indicative of changes in at least one audio feature of the plurality of audio features. The spatial range of the plurality of spatial ranges being indicative of a position of a listener in the environment.

The applying of the correction value may include adjusting at least one of reverb, bass, mid, treble, presence, gain, or compression of the input audio.

The method for optimizing the input audio may further include transmitting, from an UWB transmitter and towards the surface, a spatial signal, the audio source and the UWB transmitter being located at a same location, receiving, using a plurality of UWB receivers, a reflected spatial signal reflected by the surface, determining the acoustic characteristic of the surface by processing, using the AI model, the reflected spatial signal with the input audio, and adjusting, using the correction value, the at least one audio feature of the input audio transmitted from the audio source based on the acoustic characteristic. The reflected spatial signal may be indicative of an acoustic characteristic of the surface,

The method for optimizing the input audio may further include pre-training the AI model using sequence-wise attention between the UWB spatial data of the environment and the plurality of audio features.

According to an aspect of the present disclosure, a method for optimizing an audio experience in an environment includes collecting UWB signal data and audio data reflected from a plurality of surfaces in the environment, extracting audio features from the audio data, extracting, from the UWB signal data, spatial characteristics and acoustic characteristics of the environment, training an audio encoder using the audio features to learn a representation of the audio data, training a UWB encoder using the spatial characteristics and the acoustic characteristics to learn a representation of the UWB signal data, determining a correlation between the audio features and the spatial characteristics and the acoustic characteristics by combining the representation of the audio features with the representation of the UWB signal data, training an AI model based on the correlation, determining, using the trained AI model, a plurality of audio parameters, and optimizing the audio experience by applying the plurality of audio parameters to the audio data. The audio features include at least one of an amplitude, a frequency, or a spectrogram corresponding to the environment.

The method for optimizing the audio experience may further include transmitting UWB signals from a training UWB transmitter, and generating the UWB signal data by receiving, by a plurality of pre-configured UWB receivers, reflected UWB signals reflected from the plurality of surfaces in the environment. A training audio source transmitting the audio data and a pre-configured UWB transmitter may be located at a same location. The UWB signal data may be indicative of acoustic characteristics of the plurality of surfaces.

The generating of the UWB signal data may include stabilizing a channel impulse response (CIR) of the UWB signal data by applying a temperature drift compensation filter to the UWB signal data, removing clutters from the stabilized CIR of the UWB signal data using a decluttering technique, generating a magnitude and a phase of the UWB signal data using a transformation technique on the decluttered CIR, unwrapping the phase of the UWB signal data, and removing at least one spurious peak in the magnitude and the unwrapped phase of the UWB signal data using a cell-average constant false alarm rate (CA-CFAR) detection technique.

The applying of the temperature drift compensation filter may include determining a temperature of the plurality of pre-configured UWB receivers.

The method for optimizing the audio experience may further include determining a phase difference of arrival (PDOA) between phases of the UWB signal data post the removing of the at least one spurious peak, selecting a corresponding angle of arrival (AOA) that corresponds to the PDOA by comparing the PDOA with a stored correlation between known PDOA values and AOA values, generating an AOA-adjusted UWB signal data by adjusting a field of view (FOV) of the plurality of pre-configured UWB receivers based on the corresponding AOA, and combining the AOA-adjusted UWB signal data from each of the plurality of pre-configured UWB receivers prior to the training of the UWB encoder.

The extracting of the audio features may include determining, using a transformation technique, a plurality of frequencies of sounds in the audio data, determining, using an extraction technique, a plurality of Mel-frequency cepstral coefficients (MFCC) based on the plurality of frequencies of sounds, determining, using a spectral analysis technique, at least one qualitative feature of a reflected training audio data, and extracting the audio features by combining the plurality of MFCC with the at least one qualitative feature.

According to an aspect of the present disclosure, an electronic device for processing an audio signal includes one or more processors including processing circuitry, and memory storing instructions. The instructions, when executed by the one or more processors individually or collectively, cause the electronic device to receive the audio signal from an audio source in an environment, process the audio signal using an AI model, estimate, using the AI model, a correction value to be applied to the audio signal for each range of a plurality of spatial ranges in the environment, and optimize the at least one audio feature for a spatial range of the plurality of spatial ranges by applying the correction value to the audio signal. The audio signal having been reflected from a surface in the environment. The AI model having been pre-trained with a correlation between UWB spatial data of a plurality of surfaces in the environment and a plurality of audio features including at least one of an amplitude, a frequency and a spectrogram corresponding to the environment. The correction value being indicative of changes in at least one audio feature of the plurality of audio features. The spatial range being indicative a position of a listener in the environment.

The UWB spatial data may include one or more of a material characteristic of objects in the environment, a material characteristic of at least one of a wall or floor bounding the environment, or a geometry of the environment.

The instructions, when executed by the one or more processors individually or collectively, may further cause the electronic device to transmit, from an UWB transmitter and towards the surface, a spatial signal, receive, using a plurality of UWB receivers, a reflected spatial signal reflected by the surface, determine the acoustic characteristic of the surface by processing, using the AI model, the reflected spatial signal with the audio signal, and adjust, using the correction value, the at least one audio feature of the audio signal transmitted from the audio source based on the acoustic characteristic. The audio source and the UWB transmitter may be located at a same location. The reflected spatial signal may be indicative of an acoustic characteristic of the surface.

The instructions, when executed by the one or more processors individually or collectively, may further cause the electronic device to pre-train the AI model using sequence-wise attention between the UWB spatial data of the environment and the plurality of audio features.

According to an aspect of the present disclosure, an electronic device for processing an audio signal includes one or more processors including processing circuitry, and memory storing instructions. The instructions, when executed by the one or more processors individually or collectively, cause the electronic device to collect UWB signal data and audio data reflected from a plurality of surfaces in an environment, extract audio features from the audio data, the audio features including at least one of an amplitude, a frequency, or a spectrogram corresponding to the environment, extract, from the UWB signal data, spatial characteristics and acoustic characteristics of the environment, train an audio encoder using the audio features to learn a representation of the audio data, train a UWB encoder using the spatial characteristics and the acoustic characteristics to learn a representation of the UWB signal data, determine a correlation between the audio features and the spatial characteristics and the acoustic characteristics by combining the representation of the audio features with the representation of the UWB signal data, train an AI model based on the correlation, determine, using the trained AI model, a plurality of audio parameters for an optimal audio experience, and optimize an audio experience by applying the plurality of audio parameters to the audio data.

The instructions, when executed by the one or more processors individually or collectively, may further cause the electronic device to transmit UWB signals from a training UWB transmitter, and generate the UWB signal data by receiving, by a plurality of pre-configured UWB receivers, reflected UWB signals reflected from the plurality of surfaces in the environment. A training audio source transmitting the audio data and a pre-configured UWB transmitter may be located at same location. The UWB signal data may be indicative of acoustic characteristics of the plurality of surfaces.

The instructions, when executed by the one or more processors individually or collectively, may further cause the electronic device to stabilize a CIR of the UWB signal data by applying a temperature drift compensation filter to the UWB signal data, remove clutters from the stabilized CIR of the UWB signal data using a decluttering technique, generate a magnitude and a phase of the UWB signal data using a transformation technique on the decluttered CIR, unwrap the phase of the UWB signal data, and remove at least one spurious peak in the magnitude and the unwrapped phase of the UWB signal data using a CA-CFAR detection technique.

The instructions, when executed by the one or more processors individually or collectively, may further cause the electronic device to determine a temperature of the plurality of pre-configured UWB receivers.

The instructions, when executed by the one or more processors individually or collectively, may further cause the electronic device to determine a PDOA between phases of the UWB signal data post the removal of at the least one spurious peak, select a corresponding AOA that corresponds to the PDOA by comparing the PDOA with a stored correlation between known PDOA values and AOA values, generate an AOA-adjusted UWB signal data by adjusting a FOV of the plurality of pre-configured UWB receivers based on the corresponding AOA, and combine the AOA-adjusted UWB signal data from each of the plurality of pre-configured UWB receivers prior to the training of the UWB encoder.

The instructions, when executed by the one or more processors individually or collectively, may further cause the electronic device to determine, using a transformation technique, a plurality of frequencies of sounds in the audio data, determine, using an extraction technique, a plurality of MFCC based on the plurality of frequencies of sounds, determine, using a spectral analysis technique, at least one qualitative feature of a reflected training audio data, and extract the audio features by combining the plurality of MFCC with the at least one qualitative feature.

To further clarify the advantages and features of the present disclosure, a more particular description of the disclosure is rendered by reference to specific embodiments thereof, which is illustrated in the appended drawings. Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates a schematic showing a system for optimizing an input audio, in accordance with an embodiment of the present disclosure;

FIG. 2 illustrates a detailed schematic of the system, in accordance with an embodiment of the present disclosure;

FIG. 3A illustrates an exemplary interaction between different modules for optimizing the input audio, in accordance with an embodiment of the present disclosure;

FIG. 3B illustrates an exemplary process flow of optimizing the input audio, in accordance with an embodiment of the present disclosure;

FIG. 4 illustrates an exemplary process flow of generating ultra-wideband (UWB) embeddings, in accordance with an embodiment of the present disclosure;

FIG. 5 shows a first graph and a second graph showing CIR before and after temperature drift compensation, in accordance with an embodiment of the present disclosure;

FIG. 6 illustrates an exemplary process for generating transformed magnitude and phase data, in accordance with an embodiment of the present disclosure;

FIG. 7 illustrates an exemplary flow for the removal of at least one spurious peak in the generated magnitude, in accordance with an embodiment of the present disclosure;

FIG. 8 illustrates an exemplary flow for adjusting the field-of-view (FOV) of UWB receivers, in accordance with an embodiment of the present disclosure;

FIG. 9 illustrates two graphs showing relationships between normal frequency and Mel-frequency, in accordance with an embodiment of the present disclosure;

FIG. 10 illustrates a block diagram for training the artificial intelligence (AI) model, in accordance with an embodiment of the present disclosure;

FIG. 11 illustrates a schematic for optimizing the audio experience by optimizing an input audio from an audio source, in accordance with an embodiment of the present disclosure;

FIG. 12 illustrates a flow chart of the method for optimizing an input audio, in accordance with an embodiment of the present disclosure; and

FIG. 13A and 13B illustrates a flow chart of a method for optimizing audio experience in an environment, in accordance with an embodiment of the present disclosure.

### DETAILED DESCRIPTION

For the purpose of promoting an understanding of the principles of the present disclosure, reference is made to various embodiments and specific language to be used to describe the same. It is nevertheless to be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It is to be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It may be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore may not necessarily be taken as limiting factors to the proposed disclosure.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

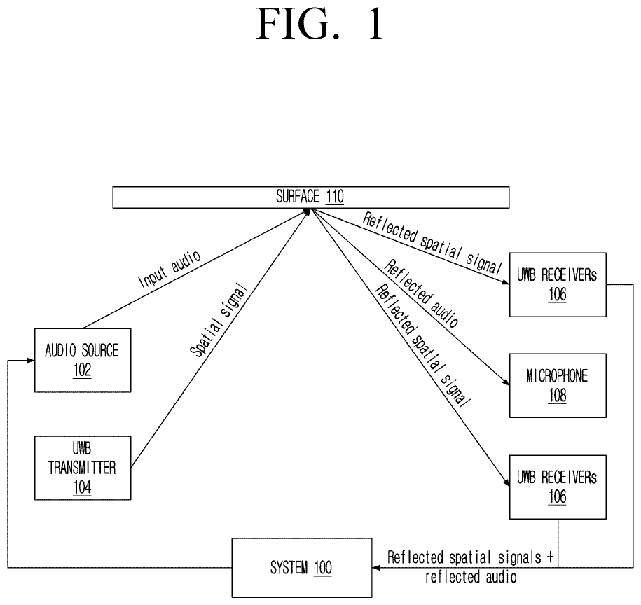

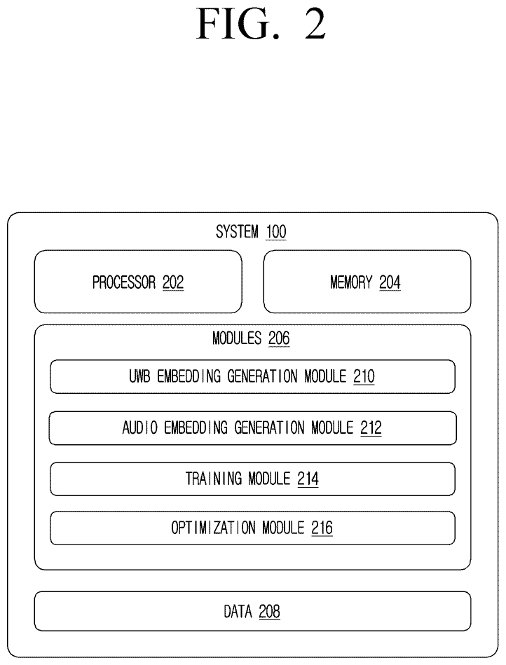

For the sake of clarity, the first digit of a reference numeral of each component of the present disclosure may be indicative of the figure number, in which the corresponding component is shown. For example, reference numerals starting with digit “1” may be shown at least in FIG. 1. Similarly, reference numerals starting with digit “2” may be shown at least in FIG. 2.

FIG. 1 illustrates a schematic showing a system 100 for optimizing an input audio, in accordance with an embodiment of the present disclosure. In one or more embodiments of the present disclosure, the system 100 may refer to an electronic device. The system 100 may be configured to optimize the input audio for production by an audio source 102. The system 100 may optimize the input audio in such a way that any change in the input audio caused by being reflected from a surface 110 may be reverted and the input audio may be substantially similar and/or the same as to the input audio. The changes in the input audio caused by the reflection may include, but not be limited to, a change in the frequency of a portion of the input audio caused by the surface for a spatial range of the plurality of spatial ranges in the environment. The spatial range of the plurality of spatial ranges may be indicative of a position of a listener in the environment. The changes in the input audio may be dependent on the type of surface 110. For example, a concrete wall may cause different changes in the input audio as compared to the changes caused by a wood panel, a glass panel, or the like. The system 100 of the present disclosure may identify the type of surface 110 based on the changes in the input audio using an artificial intelligence (AI) model. Further, the system 100 may employ ultra-wideband (UWB) transducers to collect spatial signals for training the AI model and subsequently predicting the changes.

For example, the system 100 may interact with the audio source 102 to produce the input audio and a microphone 108 that may be configured to capture reflected audio. In addition, the system 100 may interact with a UWB transmitter 104 that may transmit a spatial signal towards the surface 110 and a plurality of UWB receivers 106 that may be configured to capture reflected spatial signal coming from the surface 110. The UWB transmitter 104 and the plurality of UWB receivers 106 may be directional in nature. Further, placing the UWB transmitter 104 with the audio source 102 and UWB receivers 106 with the microphone 108 may provide spatial information about the source and the listener that may enable the AI model to optimize the input audio with relatively high precision. Although FIG. 1 illustrates a pair of UWB receivers 106, the present disclosure is not limited in this regard, and a greater number of UWB receivers 106 (e.g., greater than two) may be employed in accordance with the present disclosure. For example, the AI model of the system 100 may be trained using a dataset that establishes the correlation between the changes in the reflected UWB signal and the reflected audio signal, and based on the correlation, the AI model may predict the changes in the input audio. A detailed structure of the system 100 and an operation thereof is described in forthcoming paragraphs.

FIG. 2 illustrates a detailed schematic of the system 100, in accordance with an embodiment of the present disclosure. The system 100 may include different components that may operate synergistically to optimize an audio experience. For example, the system 100 may include a processor 202, a memory 204, modules 206, and data 208. The memory 204, for example, may store the instructions to carry out the operations of the modules 206. The modules 206 and the memory 204 may be coupled to the processor 202.

The processor 202 may be and/or may include a single processing unit or several units, all of which may include multiple computing units. The processor 202 may be implemented as one or more microprocessors, microcomputers, microcontrollers, digital signal processor, central processing units, state machines, logic circuitries, and/or any devices that manipulate signals based on operational instructions. Among other capabilities, the processor 202 may be configured to fetch and/or execute computer-readable instructions and/or data stored in the memory 204.

The memory 204 may be and/or may include, but not be limited to, any non-transitory computer-readable medium known in the art including, for example, volatile memory 204, such as, but not limited to, static random-access memory (SRAM) and dynamic random-access memory (DRAM), and/or non-volatile memory, such as, but not limited to, read-only memory (ROM), erasable programmable ROM (EPROM), flash memories, hard disks, optical disks, magnetic tapes, or the like.

The modules 206 may be and/or may include, but not be limited to, routines, programs, objects, components, data structures, or the like, which may perform particular tasks and/or implement data types. The modules 206 may also be implemented as, signal processors, state machines, logic circuitries, and/or any other device or component that may manipulate signals based on operational instructions.

The modules 206 may be implemented in hardware, instructions executed by a processing unit, or by a combination thereof. The processing unit may be and/or may include a computer, a processor (e.g., the processor 202), a state machine, a logic array, or any other suitable devices capable of processing instructions. The processing unit may be and/or may include a general-purpose processor that may execute instructions that may cause the general- purpose processor to perform the required tasks and/or, the processing unit may be and/or may include dedicated (or customized) hardware for performing the required functions. In an embodiment of the present disclosure, the modules 206 may be and/or may include machine-readable instructions (software) which, when executed by one or more processors (e.g., processor 202, processing unit) individually or collectively, may perform any of the described functionalities. Further, the data 208 may serve, amongst other things, as a repository for storing data that may be processed, received, generated, or the like by one or more of the modules 206. The data 208 may include information and/or instructions to perform activities by the processor 202.

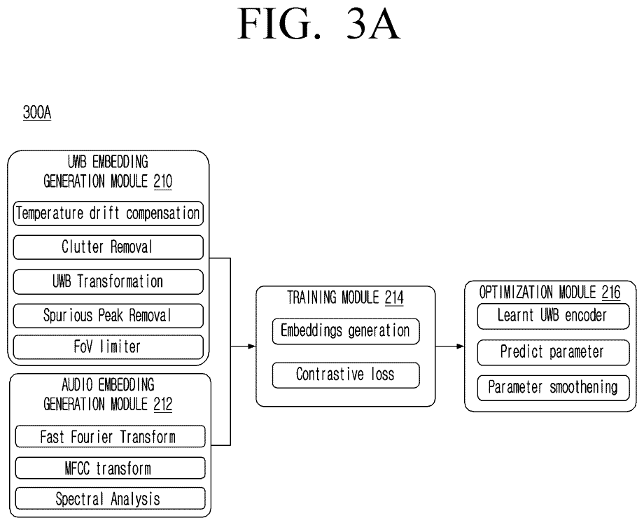

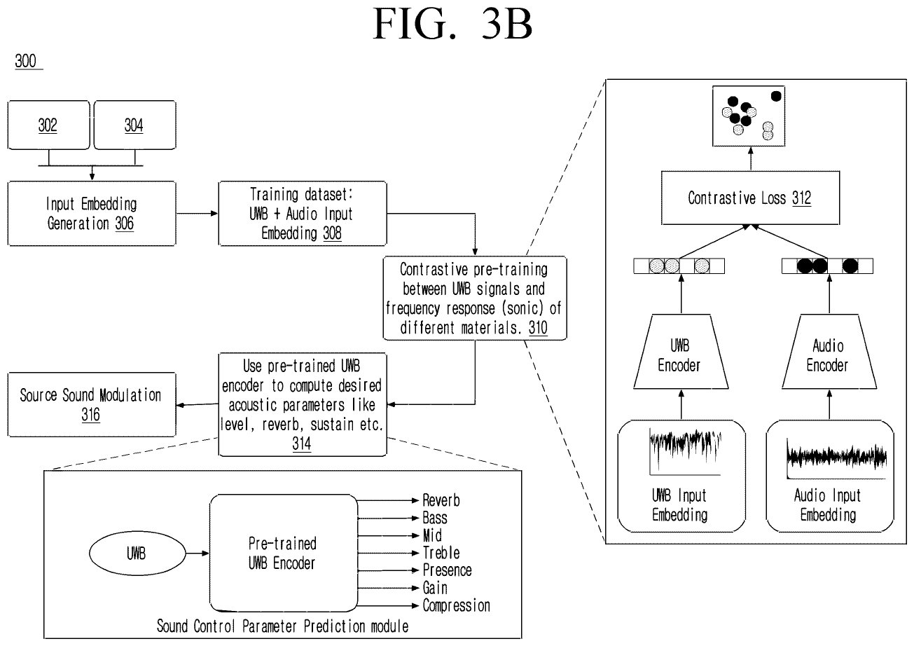

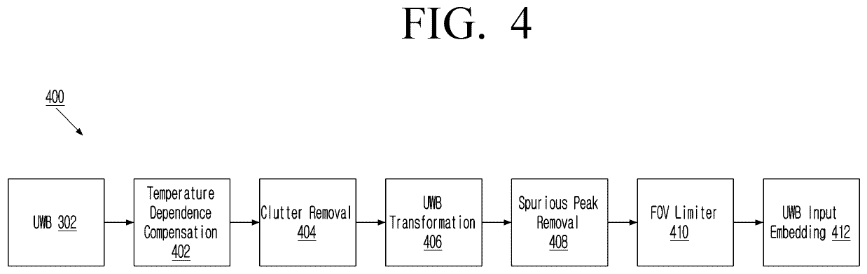

The modules 206 may perform different functionalities that may include, but may not be limited to, optimizing the input audio. Accordingly, the modules 206 may include a UWB embedding generation module 210, an audio embedding generation module 212, a training module 214, and an optimization module 216. For example, the at least one processor 202 may be configured to perform an operation by actuating (executing) the aforementioned modules 206. The functionalities of the modules 206 are described with reference to FIGS. 3A, 3B, and 4.

FIG. 3A illustrates an exemplary interaction 300A between different modules 206 for optimizing the input audio, in accordance with an embodiment of the present disclosure. FIG. 3B illustrates an exemplary process flow 300 of optimizing the input audio, in accordance with an embodiment of the present disclosure. FIG. 4 illustrates an exemplary process flow 400 of generating UWB embeddings, in accordance with an embodiment of the present disclosure.

The operation of the system 100 and corresponding modules 206 may be split into two parts. The first part may generally refer to training of the AI model, and the second part may generally refer to the use the AI model (inference) to optimize the input audio.

Referring to FIGS. 3A and 3B, the audio embedding generation module 212 may process the reflected input audio 304 simultaneously (e.g., at substantially the same time) with the UWB embedding generation module 210. The audio embedding generation module 212 may generate an input audio for production (output) by the audio source 102. The audio embedding generation module 212 may also receive input audio data 304 collected by the microphone 108 after being reflected from the plurality of surfaces in the environment. The audio embedding generation module 212 may extract training audio embeddings in the form of audio features. The audio features may include, but are not limited to, an amplitude, a frequency, or a spectrogram corresponding to the environment. The audio embedding generation module 212, as a part of extracting the audio features, may convert time domain audio data into frequency domain at block 306. The audio embedding generation module 212 may then extract the Mel spectrum features. The audio embedding generation module 212 may extract the spectral centroid, the spectrum flux, and the spectral contrast features in the form of the spectral feature vector, which may be referred to as the audio input embedding.

Referring to FIGS. 3A, 3B, and 4, the UWB embedding generation module 210 may be configured to generate UWB signals that may be used to train the AI model. The UWB embedding generation module 210 may generate and relay the UWB signal of a predefined frequency and amplitude to the training UWB transmitter 104. The UWB embedding generation module 210 may also receive reflected UWB signal data 302 from the plurality of UWB receivers 106 that are preconfigured to capture the UWB signals from a plurality of surfaces in the environment. Subsequent to the UWB signal data 302 being received, the UWB embedding generation module 210 may process the UWB signal data 302 to generate the UWB embeddings. For example, the UWB embedding generation module 210 may perform temperature drift compensation at block 402 by modifying the received UWB signal data 302 to compensate for the change in the UWB signal data 302 caused by temperature variations to obtain temperature-compensated UWB signal data. The UWB embedding generation module 210 may also remove clutters at block 404 that may be present in the temperature-compensated reflected UWB signal data to form the decluttered UWB signal data. Further, the UWB embedding generation module 210 may transform the decluttered UWB signal data at block 406 from the time domain to generate a magnitude and a phase of the reflected UWB signal data 302 using a transformation technique, such as, for example, a Fourier transformation. Further, the UWB embedding generation module 210 may unwrap the phase of the decluttered UWB signal data. Once the phase is unwrapped, the UWB embedding generation module 210 may remove at least one spurious peak in the generated magnitude and wrapped phase using a cell-average constant false alarm rate (CA-CFAR) detection technique.

The UWB embedding generation module 210 may remove at least one spurious peak at block 408 in the generated magnitude and phase. In an embodiment, the UWB embedding generation module 210 may adjust a field of view (FOV) of the UWB signal data 302 at block 410 to obtain the AOA-adjusted UWB signal data. The AOA-adjusted UWB signal data may be termed as UWB embedding 412 that may be used to train the AI model. The combination of the UWB embedding and the audio embedding may be generated at block 306. The combination, in one example, may be referred to as a training dataset.

For example, the training module 214 may receive the training dataset of the UWB embedding and audio input embedding to train the encoder models at block 308. For example, the training module 214 may train a UWB encoder using the UWB embedding and an audio encoder using the audio embedding. Thereafter, the training module 214 may train a transformer 310 using a contrastive pre-training technique. As part of the contrastive pre-training, the training module 214 may use an AI model to encode UWB audio semantics by maximizing agreement between similar pairs of samples (e.g., UWB and audio embeddings) and minimizing agreement between dissimilar pairs of samples.

The training module 214 may train the transformer 310 on a contrastive loss function 312. The contrastive loss function may refer to a type of loss function commonly used in machine learning and deep learning, particularly for tasks involving similarity learning, representation learning, and metric learning. The contrastive loss function may be used to train the AI model to distinguish between similar and dissimilar pairs of data points by minimizing the distance metric between them. The AI model learns to transform the UWB embedding and audio embedding in a space where similar data points may be closer together (e.g., a distance may be less than or equal to a threshold), and dissimilar points may be farther apart (e.g., a distance may be greater than the threshold).

For example, the optimization module 216 may use the trained AI model to optimize the audio experience at block 314. The optimization module 216 may send the output audio to the audio source 102 for production thereof. In addition, the optimization module 216 may generate spatial signals for transmission by the UWB transmitter 104. In addition, the optimization module 216 may receive reflected spatial signals from the UWB receivers 106 and reflect audio input from the microphone 108. The optimization module 216 may process the reflected spatial and audio inputs using the trained encoder to predict the acoustic parameters such as, but not limited to, level, reverb, sustain, or the like. The optimization module 216, at block 316, may smoothen the parameters by determining the changes to be made to the input audio so that the changes in the acoustic parameters are offset, and subsequent reflected input audio may be substantially similar and/or the same as the original input audio. A manner in which the aforementioned processes are performed is described in subsequent embodiments.

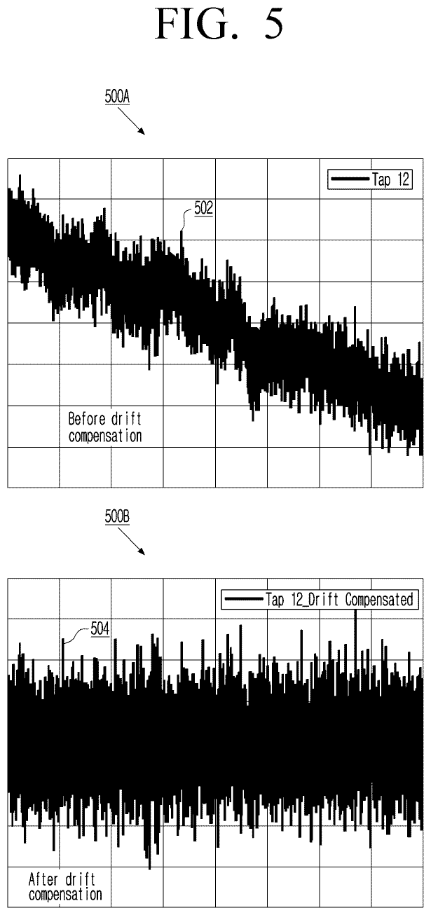

As described above, the UWB embedding generation module 210 may compensate for any change in the signal caused by temperature. Referring to FIG. 5 a first graph 500A and a second graph 500B showing channel impulse response (CIR) before and after temperature drift compensation are illustrated, in accordance with an embodiment of the present disclosure. The spatial signals may be generated by the UWB transmitter 104 in the form of a set of pulses in a time domain wherein each pulse is may be referred to as a channel impulse response (CIR). Each set of pulses transmitted at a given time may be categorized as a bin. The transmitted CIRs may be reflected by surfaces in the environment and may be received by the UWB receivers 106. The CIRs of the received spatial signal may be affected by the ambient temperature around the UWB receivers 106. Alternatively, the temperature change may be caused by heat produced on a component mounted on a printed circuit board (PCB) onto which the UWB receivers 106 may be mounted.

The temperature variation may cause the UWB receiver 106 to induce drift in the spatial signal. The drift may be understood as a gradual variation in the CIR over a period of time. The variation in the CIR may cause an inaccurate depth measurement and/or inaccurate generation of UWB embedding. As shown in the first graph 500A of FIG. 5, the CIR 502 may vary temporally resulting in an inclined plot even though the spatial position of the UWB receivers 106 and the surfaces may remain unchanged.

In order to compensate for the temperature-induced drift, the UWB embedding generation module 210 may determine the temperature of UWB receivers 106. The temperature may be determined by receiving a temperature reading from a temperature probe thermally coupled to the UWB receivers 106. The UWB embedding generation module 210 may apply a filter based on the temperature reading. Alternatively, the UWB embedding generation module 210 may directly apply an infinite impulse response (IIR) filter, for example, based on an expected (or predicted) temperature change. For example, the UWB embedding generation module 210 may implement a 1-tap IIR filter technique. The UWB embedding generation module 210 may determine an instantaneous error ∈m(τ) in the CIR using an equation similar to Equation 1.

$$( τ ) = h ( tm - 1 , τ ) - href ( τ ) and Filtered error ( τ ) = ( 1 - α ) \cdot ϵ + α \cdot ( τ ) , and \\ Drift compensated CIR hc ( tm , τ ) = h ( tm - 1 , τ ) - ϵ ( τ ) \qquad [ Equation 1 ]$$

Referring to Equation 1, h(tm−1, τ) may represent the current raw CIR, href(τ) represent a reference CIR (first CIR), and α represent a filter parameter.

The UWB embedding generation module 210 may determine the drift compensated CIR 504 to stabilize the CIR, as shown in the second graph 500B.

The UWB embedding generation module 210 may remove clutters from the drift-compensated CIR. The clutter may refer to unwanted and/or spurious signals that may obscure the true reflections of interest, which may be typically caused by objects near the surfaces in the environment that may scatter and/or reflect the spatial signal. For example, the clutter may cause false echoes and/or additional multipath components in the CIR.

In an embodiment, the clutter may be assumed to be constant over a period of time and the UWB embedding generation module 210 may implement a decluttering technique. The UWB embedding generation module 210, during the implementation of the decluttering technique, may determine the clutter as a mean value of a single CIR tap. Thereafter, the UWB embedding generation module 210 may subtract the determined CIR tap for a given time with the corresponding CIR tap of the spatial signal generated by the UWB embedding generation module 210 for production by the UWB transmitter 104. The clutter may be removed using a formula that may be represented as an equation similar to Equation 2.

$${x}_{k} = {x}_{t} - \frac{1}{L} {\sum }_{i = 1}^{i = W L} {x}_{i} \qquad [ Equation 2 ]$$

Referring to Equation 2, x_k may represent the CIR with removed clutter, x_t may represent the mean CIR, and x_i may represent the ith previous CIR from the current window.

Subsequent to the decluttered CIR being obtained, the UWB embedding generation module 210 may unwrap the decluttered CIR.

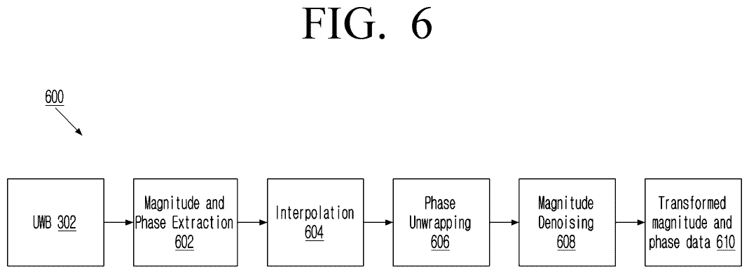

Referring to FIG. 6, an exemplary process 600 for transforming the UWB data, in accordance with an embodiment of the present disclosure, is illustrated. The UWB embedding generation module 210 may process and extract the magnitude and phase of CIRs of each bin at block 602. Subsequent to the phase and magnitude being extracted, the UWB embedding generation module 210 may determine if the extracted magnitude and phase are sufficient to perform further processing. In case the extracted magnitude and phase are not sufficient, the UWB embedding generation module 210 may perform a known interpolation technique, at block 604, to synthetically generate additional magnitude and phase values.

The UWB embedding generation module 210 may wrap the phases to potentially avoid and/or reduce the effect of a wrap-around phenomenon at block 606. The wrap-around phenomenon may refer to a phenomenon in which the phase of CIR may exceed and/or fall below a specified range, potentially causing the phase value to return to the starting point during the processing. Since phase values may be periodic by nature, if the wrap-around phenomenon is not corrected, it may result in the loss of spatial information in the spatial data about the surfaces. For example, the UWB embedding generation module 210 may implement a phase unwrapping technique. Phase unwrapping may refer to a process used to remove discontinuities or jumps in the phase of CIR that occur due to phase wrapping. The phase unwrapping technique may be used when the phase values of a signal exceed a defined range (e.g., −π to π, or 0 to 2π) and wrap around. However, the present disclosure is not limited in this regard. The phase unwrapping technique may include adding and/or subtracting 2π to the phase values when the difference between consecutive phase values is greater than a threshold value (e.g., π).

Subsequent to the phase unwrapping being performed, the UWB embedding generation module 210 may remove noise in the generated magnitude at block 608. The noise may refer to at least one spurious peak in the magnitude generated by the UWB embedding generation module 210. The UWB embedding generation module 210 may remove the spurious peaks by determining a mean of the magnitude and subtracting from an instantaneous value of the magnitude for a given time. Subsequent to the subtraction, the UWB embedding generation module 210 may generate the transformed magnitude and phase data.

According to the present disclosure, in an embodiment, not all the spurious peaks may be removed, and, in such an embodiment, the UWB embedding generation module 210 may use additional techniques to remove the at least one spurious peak.

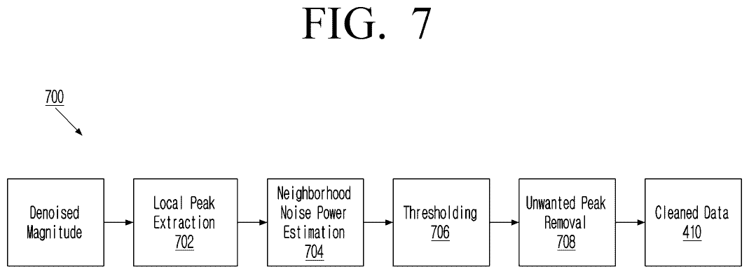

FIG. 7 illustrates an exemplary flow 700 for the removal of at least one spurious peak in the generated magnitude, in accordance with an embodiment of the present disclosure. Initially, the UWB embedding generation module 210 may receive the denoised magnitude at block 702. Thereafter, the UWB embedding generation module 210, at block 704, may segment the denoised magnitude into different taps and extract local peaks therefrom. The local peaks may be determined by comparing the magnitude values of CIRs in each tap and the CIR with the highest magnitude may be selected as the local peak.

The UWB embedding generation module 210 may estimate a neighborhood noise power at block 706 for each tap using the local peaks for different taps. Subsequent to the neighborhood noise power being estimated, the UWB embedding generation module 210 may compare the calculated neighborhood noise power with a threshold value at block 708. Based on a result of the comparison, the UWB embedding generation module 210 may identify CIRs in the taps that have an estimated neighborhood noise power that may be greater than a threshold value, and may remove such identified CIRs at block 710. At block 712, clean data having accurate magnitudes of the CIR may be obtained.

The UWB embedding generation module 210 may include the extracted phase and cleaned magnitude of the CIRs of the reflected spatial data. According to the present disclosure, the microphone 108 may be and/or may include a directional microphone and may be configured to capture the audio data reflected from the surfaces and to disregard other background noise. However antennas of the UWB receivers 106 may have a relatively wide (large) FOV. For example, in some cases, the antennas of the UWB receivers 106 may be and/or include omnidirectional antennas and/or may have an FOV of 180 degrees (°) (e.g., −90° to +90°). However, the present disclosure is not limited in this regard. Accordingly, the CIRs of the spatial data collected by the UWB receivers 106 may include additional spatial data that may not correspond to the direction from which the audio data is being received.

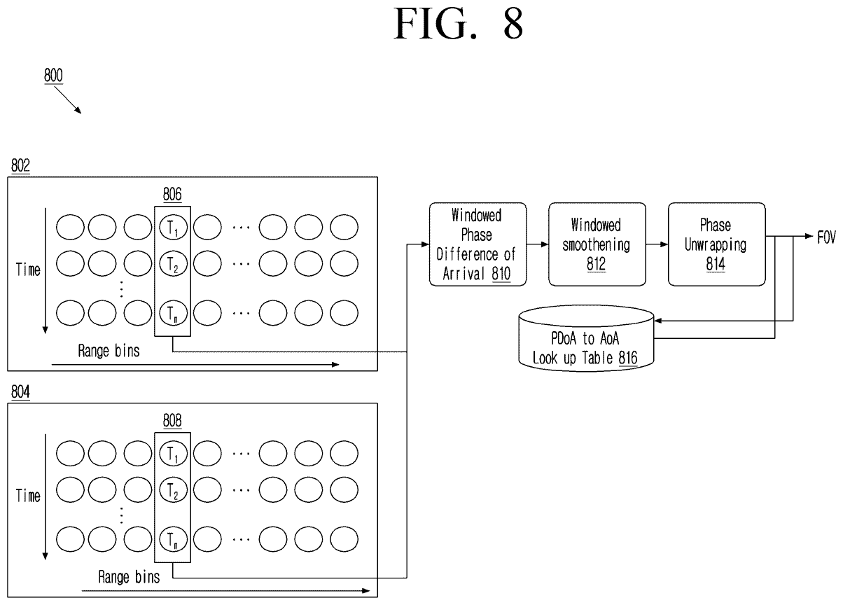

An exemplary embodiment showing adjustment of FOV is described with reference to FIG. 8, which illustrates an exemplary flow 800 for adjusting the FOV of the UWB receivers 106, in accordance with an embodiment of the present disclosure. In the exemplary flow 800, the UWB embedding generation module 210 may receive two sets of cleaned CIRs (e.g., a first cleaned CIR 802 and a second cleaned CIR 804). The UWB embedding generation module 210 may compare the phase of the first and second cleaned CIRs 802 and 804 for a given time stamp generated from two or more different UWB receivers 106. Such an approach may ensure that the process of limiting FOV is accurate. For example, the UWB embedding generation module 210 may select two bins (e.g., a first bin 806 and a second bin 808) that may be associated with the two different UWB receivers, and perform a phase difference of arrival (PDOA) process between first and second bins 806 and 808, at block 810. As used herein, the PDOA may represent the phase difference between the two different UWB receivers. In an embodiment, the UWB embedding generation module 210 may compute the phase difference for each bin. Further, the UWB embedding generation module 210 may smoothen the calculated PDOA, at block 812, by discarding the PDOA that may be greater than a threshold value.

Thereafter, the UWB embedding generation module 210 may unwrap the PDOA of the bins at block 814. The UWB embedding generation module 210 may compare the PDOA with a lookup table that may be stored in a database 816. The lookup table may include a correlation between the PDOA and angle of arrival (AOA) with an FOV of the microphone 108. The UWB embedding generation module 210 may compare all the PDOAs and select the corresponding AOA. Accordingly, the UWB embedding generation module 210 may adjust the FOV of the UWB receivers 106 with the selected AOA.

The UWB embedding generation module 210 may generate an AOA-adjusted UWB signal data. The cleaned magnitude and unwrapped phase may be the UWB input embedding that may be used to train the AI model.

For example, the audio embedding generation module 212 may be configured to perform the analysis of the audio data. Referring to FIG. 3A, the audio embedding generation module 212 may determine a Fast Fourier Transform (FFT) to convert the time domain audio into the frequency domain to determine a plurality of frequencies in the audio data. The conversion to the frequency domain may assist in contrastive pre-training by the training module 214. For example, the audio embedding generation module 212 may generate the FFT coefficient for each frequency using a formula that may be represented as an equation similar to Equation 3.

$${X}_{k} = {\sum }_{n = 0}^{N - 1} {e}^{- 2 π i k ( \frac{n}{N} )} {x}_{n} \qquad [ Equation 3 ]$$

Referring to Equation 3, k may represent a frequency component index, X_k may represent a FFT coefficient for a kth frequency component, n may represent a time index, x_n may represent a signal value at the time index n, i may represent the square root of −1 (e.g., √(−1)), and N may represent a length of the signal.

The audio embedding generation module 212 may determine a plurality of Mel-frequency cepstral coefficients (MFCC) based on the determined plurality of frequencies using an extraction technique. The audio embedding generation module 212 may determine MFCC that may be indicative of correlations between the sound captured by the microphone and sound perceived by humans (e.g., human ear). The audio embedding generation module 212 may implement a triangular band-pass filter to convert the frequency of the audio data to simulate what humans may perceive in order to extract the MFCC.

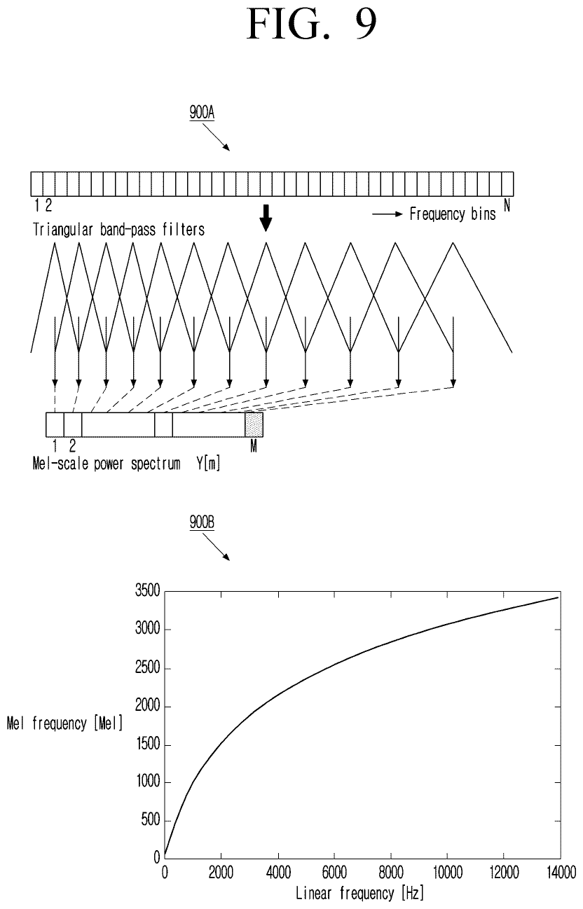

Exemplary first graph 900A and second graph 900B, as shown in FIG. 9, may illustrate relationships between normal frequency and Mel-frequency, in accordance with an embodiment of the present disclosure.

Subsequent to the audio embedding generation module 212 determining the MFCC, the audio embedding generation module 212 may perform the spectral analysis. The spectral analysis of the audio data may be performed to determine at least one qualitative feature. The at least one qualitative may include, but not be limited to, a timbre, a genre, or the like, and may be determined by calculating at least one of a spectral centroid, a spectrum flux, or a spectral contrast. The spectral centroid may refer to a metric that may be used to characterize the frequency spectrum in digital signal processing. For example, the spectral centroid may indicate where the centroid of the frequency spectrum is located. The spectral centroid may be a measure of the timbre of music. The audio embedding generation module 212 may determine the spectral centroid using a formula that may be represented as an equation similar to Equation 4.

$$Spectral Centroid = \frac{{\sum }_{n = 0}^{N - 1} f ( n ) x ( n )}{{\sum }_{n = 0}^{N - 1} x ( n )} \qquad [ Equation 4 ]$$

The spectrum flux may refer to a measure of the rate of change of the signal spectrum. The spectrum flux may be calculated by comparing the spectrum of the current frame with the spectrum of the previous frame. Spectrum flux may be used to determine the timbre of an audio signal. The audio embedding generation module 212 may determine the spectrum flux using a formula that may be represented as an equation similar to Equation 5.

$$Spectral Flux = \sqrt{{\sum }_{k = 1}^{n} {\vert {x}_{k} \vert}^{2}} \qquad [ Equation 5 ]$$

The spectral contrast may be used to classify music genres. The spectral contrast may be expressed as the difference in decibels between peaks and valleys in the frequency spectrum, which may represent the relative spectral characteristics of music. The audio embedding generation module 212 may determine the spectral contrast using a formula that may be represented as an equation similar to Equation 6.

$$Spectral Contrast = Peak ( in Decibel ) - Valley ( in Decibel ) \qquad [ Equation 6 ]$$

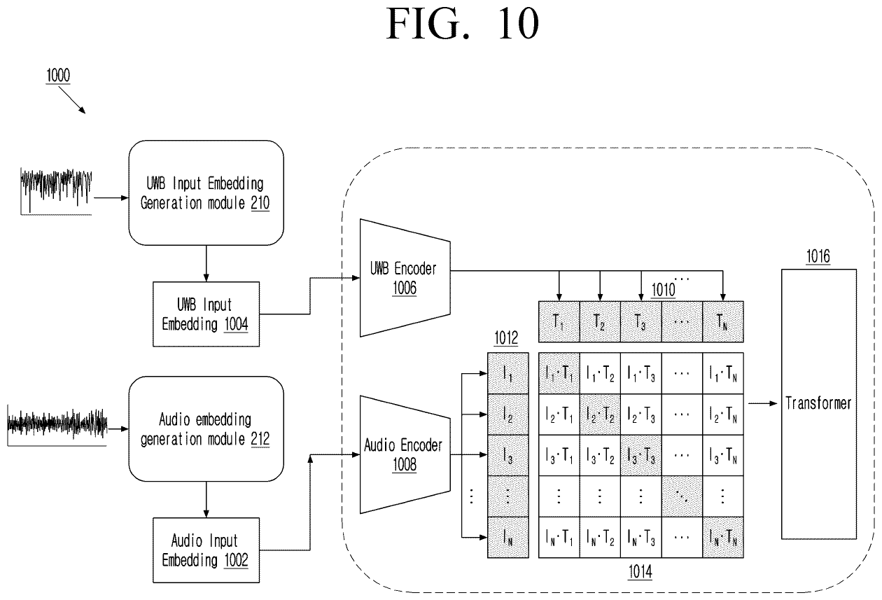

FIG. 10 illustrates a block diagram 1000 for training the AI model, in accordance with an embodiment of the present disclosure. The audio embedding generation module 212 may provide the determined MFCC and spectral analysis to the training module 214 at block 1002 in the form of the audio input embedding. Similarly, the UWB embedding generation module 210 may provide the AOA-adjusted UWB signal data to the training module 214 at block 1004 as the UWB input embedding. For example, the AOA adjusted data may be interpreted to filter out reflected signals from objects by removing signals received directly from the UWB transceiver. For example, a CIR that may have an AOA lying outside the predefined range may be filtered out.

In an embodiment, the training module 214 may process the UWB input embedding to extract spatial and acoustic characteristics of the environment and provide the extracted spatial and acoustic characteristics of the environment to a UWB encoder 1006. Simultaneously, the training module 214 may process the audio input embedding to extract acoustic features and provide the extracted acoustic features to an audio encoder 1008. For example, the audio embedding may be formed by extracting FFT, MFCC and spectral analysis features and concatenating them one after the other.

The UWB encoder 1006 may output a learned representation 1010 having information about the spatial and acoustic characteristics of the environment. Similarly, the audio encoder 1008 may output another learned representation 1012 having information about the acoustic features. The training module 214 may determine a correlation between the between the audio features and the extracted spatial and acoustics features by combining the learned representations 1012 of the audio features and learned representation 1010 of the UWB data.

The training module 214 may train the AI model 1014 using the correlation. The AI model 1014 may be trained by using a contrastive pre-training technique. Subsequent to the AI model 1014 being trained, the AI model may identify a correlation between a change in the spatial signal and the audio input that may be caused by the surface. Further, the AI model 1014 may provide a correlation value to offset the changes in the audio input. The training module 214 may deploy the AI model to the optimization module 216.

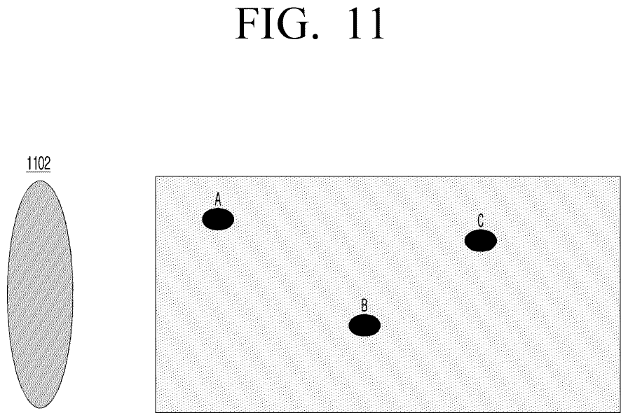

FIG. 11 illustrates a schematic 1100 for optimizing the audio experience by optimizing an input audio from an audio source 1102, in accordance with an embodiment of the present disclosure.

In order to optimize the sound experience at different locations (e.g., a first location A, a second location B, and a third location C), a user may place a UWB transmitter 104 proximate to the audio source 1102. Additionally, microphones 108 may be placed at each of the first to third locations A to C. The user may place a UWB receiver 106 at each of the first to third locations A to C. In addition, the UWB transmitter 104 and the UWB receiver 106 may be in communication with the system 100.

The audio source 1102 may be actuated (activated) along with the UWB transmitter 104, and consequently, the input audio and spatial data may be received from the microphone 108 and the UWB receiver 106 at the first location A. The received input audio and spatial data may be processed using the AI model to determine the acoustic characteristic of the surface from which the signal received at the first location A was reflected. The AI model, based on the acoustic characteristic, may provide a correlation value. The correlation value may be indicative of changes in at least one audio feature that may be made to the input audio to make the reflected input audio to be substantially similar and/or the same as the input audio produced by the audio source 1102.

The optimization module 216 may repeat the same process for each of the first to third locations A to C to optimize the audio experience.

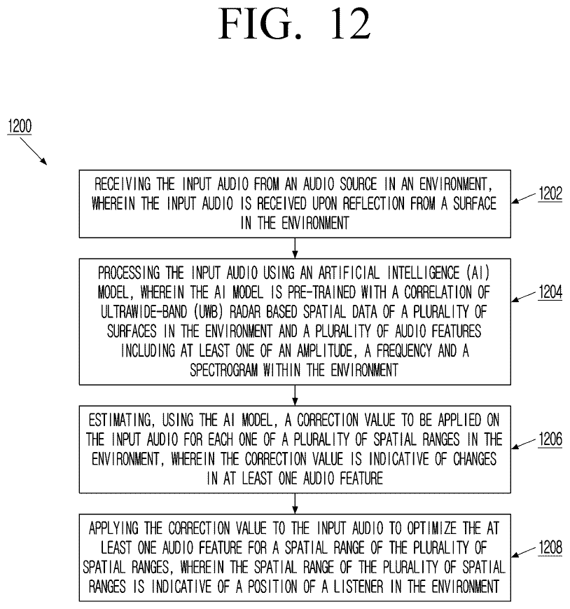

FIG. 12 illustrates a flow chart of the method 1200 for optimizing an input audio, in accordance with an embodiment of the present disclosure. The order in which the method operations are described below is not intended to be construed as a limitation, and any number of the described method operations may be combined in any appropriate order to execute the method or an alternative method. Additionally, individual operations may be deleted from the method without departing from the spirit and scope of the subject matter described herein.

The method 1200 may be performed by programmed computing devices, for example, based on instructions retrieved from non-transitory computer readable media. The computer readable media may include machine-executable or computer-executable instructions to perform all or portions of the described method. The computer readable media may be and/or may include, for example, digital memories, magnetic storage media, such as, but not limited to, magnetic disks and magnetic tapes, hard drives, optically readable data storage media, or the like.

For example, the method 1200 may be performed partially or completely by the system 100 described with reference to FIG. 2.

In an embodiment, the method 1200, at operation 1202, may include receiving the input audio from an audio source in an environment. The input audio may be received after being reflected from a surface in the environment.

At operation 1204, the method 1200 may include processing the input audio using an AI model. The AI model may be pre-trained with a correlation of ultra-wideband (UWB) based spatial data of a plurality of surfaces in the environment and a plurality of audio features including at least one of an amplitude, a frequency, or a spectrogram corresponding to the environment.

Further, at operation 1206, the method 1200 may include estimating, using the AI model, a correction value to be applied on the input audio for each one of a plurality of spatial ranges in the environment. The correction value may be indicative of changes in at least one audio feature.

At operation 1208, the method 1200 may include applying the correction value to the input audio to optimize the at least one audio feature for a spatial range of the plurality of spatial ranges. The spatial range of the plurality of spatial ranges may be indicative of a position of a listener in the environment.

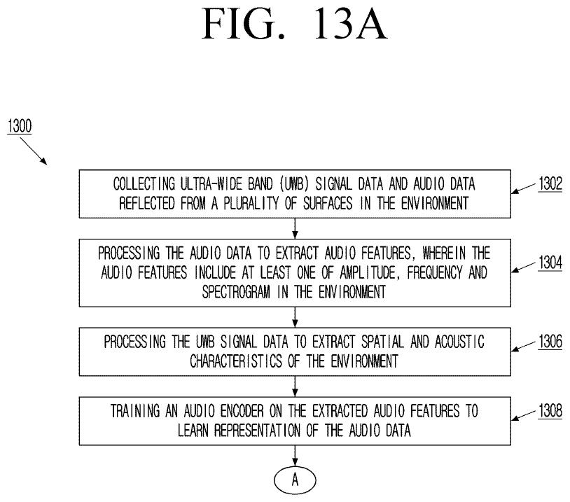

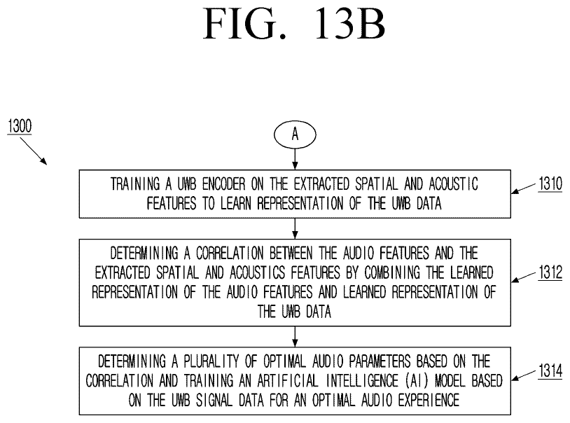

FIGS. 13A and 13B illustrates a flow chart of a method 1300 for optimizing audio experience in an environment, in accordance with an embodiment of the present disclosure. For example, the method 1300 may be performed partially or completely by the system 100 described with reference to FIG. 2.

At operation 1302, collecting ultra-wide band (UWB) signal data and audio data reflected from a plurality of surfaces in the environment.

At operation 1304, the method 1300 may include processing the audio data to extract audio features. The audio features include at least one of an amplitude, a frequency, or a spectrogram corresponding to the environment.

At operation 1306, the method 1300 may include processing the UWB signal data to extract spatial and acoustic characteristics of the environment.

At operation 1308, the method 1300 may include training an audio encoder on the extracted audio features to learn representation of the audio data;

At operation 1310, the method 1300 may include training a UWB encoder on the extracted spatial and acoustic features to learn representation of the UWB data.

At operation 1312, the method 1300 may include determining a correlation between the audio features and the extracted spatial and acoustics features by combining the learned representation of the audio features and the learned representation of the UWB data.

At operation 1314, the method 1300 may include determining a plurality of optimal audio parameters based on the correlation and training an AI model based on the correlation between the UWB signal data.

Advantageously, the aspects presented herein may provide a system that may achieve a relatively high level of precision and/or granularity in adjusting sound parameters. For example, the provided system may allow for fine-tuning of audio settings based on the specific location of individual audience members within the indoor/outdoor environment, and thereby optimizing their listening experience.

Furthermore, the aspects presented herein may further provide a system that may optimize input sound both for indoor and/or outdoor environments that may generally be dynamic in nature in which factors such as, but not limited to, audience density, room acoustics, or environmental conditions, may vary widely. The integration of UWB encoding may further provide for real-time adaptation to these changing conditions, which may result in a relatively consistent and/or relatively high-quality sound output regardless of external factors.

The aspects presented herein may further provide a system that automates the sound optimization process through UWB encoding, and thereby, may streamline sound engineering tasks, which may reduce time and/or resource costs while maintaining an optimal audio quality.

The aspects presented herein may further provide a combination of sound and UWB encoding that allows for customizable and personalized sound experiences. For example, listeners may tailor sound profiles based on user preferences, musical genres, or the like, thereby enhancing their overall audio experience.

The aspects presented herein may further provide a system that uses sound and UWB encoding that may be available on related sound systems and equipment, thereby potentially minimizing a need for upgrading and/or replacing the related sound systems and equipment. Thus, the provided system may be compatible with a wide range of indoor/outdoor venues.

The aspects presented herein may further provide a system that may gather valuable insights into user behavior, room dynamics, sound performance metrics, or the like. This data-driven approach may enable continuous optimization of sound engineering processes, which may lead to further improvements in audio quality and user satisfaction over time.

As used herein, unless specifically stated otherwise, the use of the singular includes the plural and the use of “or” means “and/or.” Furthermore, use of the terms “including” or “having” is not limiting. Any range described herein is to be understood to include the endpoints and all values between the endpoints. Features of the disclosed embodiments may be combined, rearranged, omitted, or the like, within the scope of the present disclosure to produce additional embodiments. Furthermore, certain features may sometimes be used to advantage without a corresponding use of other features.

While at least one exemplary embodiment has been presented in the foregoing detailed description, it may be appreciated that a vast number of variations exist.

What is claimed is:

1. A method for optimizing an input audio, comprising:
receiving the input audio from an audio source in an environment, the input audio having been reflected from a surface in the environment;
processing the input audio using an artificial intelligence (AI) model, the AI model having been pre-trained with a correlation between ultra-wideband (UWB) spatial data of a plurality of surfaces in the environment and a plurality of audio features comprising at least one of an amplitude, a frequency, or a spectrogram corresponding to the environment;
estimating, using the AI model, a correction value to be applied to the input audio for each range of a plurality of spatial ranges in the environment, the correction value being indicative of changes in at least one audio feature of the plurality of audio features; and
optimizing the at least one audio feature for a spatial range of the plurality of spatial ranges by applying the correction value to the input audio, the spatial range of the plurality of spatial ranges being indicative of a position of a listener in the environment.

2. The method of claim 1, wherein the applying of the correction value comprises:
adjusting at least one of reverb, bass, mid, treble, presence, gain, or compression of the input audio.

3. The method of claim 1, further comprising:
transmitting, from an UWB transmitter and towards the surface, a spatial signal, the audio source and the UWB transmitter being located at a same location;
receiving, using a plurality of UWB receivers, a reflected spatial signal reflected by the surface, the reflected spatial signal being indicative of an acoustic characteristic of the surface;
determining the acoustic characteristic of the surface by processing, using the AI model, the reflected spatial signal with the input audio; and
adjusting, using the correction value, the at least one audio feature of the input audio transmitted from the audio source based on the acoustic characteristic.

4. The method of claim 1 further comprising:
pre-training the AI model using sequence-wise attention between the UWB spatial data of the environment and the plurality of audio features.

5. A method for optimizing an audio experience in an environment, comprising:
collecting ultra-wideband (UWB) signal data and audio data reflected from a plurality of surfaces in the environment;
extracting audio features from the audio data, the audio features comprising at least one of an amplitude, a frequency, or a spectrogram corresponding to the environment;
extracting, from the UWB signal data, spatial characteristics and acoustic characteristics of the environment;
training an audio encoder using the audio features to learn a representation of the audio data;
training a UWB encoder using the spatial characteristics and the acoustic characteristics to learn a representation of the UWB signal data;
determining a correlation between the audio features and the spatial characteristics and the acoustic characteristics by combining the representation of the audio features with the representation of the UWB signal data;
training an artificial intelligence (AI) model based on the correlation;
determining, using the trained AI model, a plurality of audio parameters; and
optimizing the audio experience by applying the plurality of audio parameters to the audio data.

6. The method of claim 5, further comprising:
transmitting UWB signals from a training UWB transmitter, a training audio source transmitting the audio data and a pre-configured UWB transmitter being located at a same location; and
generating the UWB signal data by receiving, by a plurality of pre-configured UWB receivers, reflected UWB signals reflected from the plurality of surfaces in the environment, the UWB signal data being indicative of acoustic characteristics of the plurality of surfaces.

7. The method of claim 6, wherein the generating of the UWB signal data comprises:
stabilizing a channel impulse response (CIR) of the UWB signal data by applying a temperature drift compensation filter to the UWB signal data;
removing clutters from the stabilized CIR of the UWB signal data using a decluttering technique;
generating a magnitude and a phase of the UWB signal data using a transformation technique on the decluttered CIR;
unwrapping the phase of the UWB signal data; and
removing at least one spurious peak in the magnitude and the unwrapped phase of the UWB signal data using a cell-average constant false alarm rate (CA-CFAR) detection technique.

8. The method of claim 7, wherein the applying of the temperature drift compensation filter comprises:
determining a temperature of the plurality of pre-configured UWB receivers.

9. The method of claim 7, further comprising:
determining a phase difference of arrival (PDOA) between phases of the UWB signal data post the removing of the at least one spurious peak;
selecting a corresponding angle of arrival (AOA) that corresponds to the PDOA by comparing the PDOA with a stored correlation between known PDOA values and AOA values;
generating an AOA-adjusted UWB signal data by adjusting a field of view (FOV) of the plurality of pre-configured UWB receivers based on the corresponding AOA; and
combining the AOA-adjusted UWB signal data from each of the plurality of pre-configured UWB receivers prior to the training of the UWB encoder.

10. The method of claim 5, wherein the extracting of the audio features comprises:
determining, using a transformation technique, a plurality of frequencies of sounds in the audio data;
determining, using an extraction technique, a plurality of Mel-frequency cepstral coefficients (MFCC) based on the plurality of frequencies of sounds;
determining, using a spectral analysis technique, at least one qualitative feature of a reflected training audio data; and
extracting the audio features by combining the plurality of MFCC with the at least one qualitative feature.

11. An electronic device for processing an audio signal, comprising:
one or more processors comprising processing circuitry; and
memory storing instructions, wherein the instructions, when executed by the one or more processors individually or collectively, cause the electronic device to:
receive the audio signal from an audio source in an environment, the audio signal having been reflected from a surface in the environment;
process the audio signal using an artificial intelligence (AI) model, the AI model having been pre-trained with a correlation between ultra-wideband (UWB) spatial data of a plurality of surfaces in the environment and a plurality of audio features comprising at least one of an amplitude, a frequency, or a spectrogram corresponding to the environment;
estimate, using the AI model, a correction value to be applied to the audio signal for each range of a plurality of spatial ranges in the environment, the correction value being indicative of changes in at least one audio feature of the plurality of audio features; and
optimize the at least one audio feature for a spatial range of the plurality of spatial ranges by applying the correction value to the audio signal, the spatial range being indicative a position of a listener in the environment.

12. The electronic device of claim 11, wherein the UWB spatial data comprises one or more of a material characteristic of objects in the environment, a material characteristic of at least one of a wall or floor bounding the environment, or a geometry of the environment.

13. The electronic device of claim 11, wherein the instructions, when executed by the one or more processors individually or collectively, further cause the electronic device to:
transmit, from an UWB transmitter and towards the surface, a spatial signal, the audio source and the UWB transmitter being located at a same location;
receive, using a plurality of UWB receivers, a reflected spatial signal reflected by the surface, the reflected spatial signal being indicative of an acoustic characteristic of the surface;
determine the acoustic characteristic of the surface by processing, using the AI model, the reflected spatial signal with the audio signal; and
adjust, using the correction value, the at least one audio feature of the audio signal transmitted from the audio source based on the acoustic characteristic.

14. The electronic device of claim 11, wherein the instructions, when executed by the one or more processors individually or collectively, further cause the electronic device to:
pre-train the AI model using sequence-wise attention between the UWB spatial data of the environment and the plurality of audio features.

15. An electronic device for processing an audio signal, comprising:
one or more processors comprising processing circuitry; and
memory storing instructions,
wherein the instructions, when executed by the one or more processors individually or collectively, cause the electronic device to:
collect ultra-wideband (UWB) signal data and audio data reflected from a plurality of surfaces in an environment;
extract audio features from the audio data, the audio features comprising at least one of an amplitude, a frequency, or a spectrogram corresponding to the environment;
extract, from the UWB signal data, spatial characteristics and acoustic characteristics of the environment;
train an audio encoder using the audio features to learn a representation of the audio data;
train a UWB encoder using the spatial characteristics and the acoustic characteristics to learn a representation of the UWB signal data;
determine a correlation between the audio features and the spatial characteristics and the acoustic characteristics by combining the representation of the audio features with the representation of the UWB signal data;
train an artificial intelligence (AI) model based on the correlation;
determine, using the trained AI model, a plurality of audio parameters for an optimal audio experience; and
optimize an audio experience by applying the plurality of audio parameters to the audio data.

16. The electronic device of claim 15, wherein the instructions, when executed by the one or more processors individually or collectively, further cause the electronic device to:
transmit UWB signals from a training UWB transmitter, a training audio source transmitting the audio data and a pre-configured UWB transmitter being located at same location; and
generate the UWB signal data by receiving, by a plurality of pre-configured UWB receivers, reflected UWB signals reflected from the plurality of surfaces in the environment, the UWB signal data being indicative of acoustic characteristics of the plurality of surfaces.

17. The electronic device of claim 16, wherein the instructions, when executed by the one or more processors individually or collectively, further cause the electronic device to:
stabilize a channel impulse response (CIR) of the UWB signal data by applying a temperature drift compensation filter to the UWB signal data;
remove clutters from the stabilized CIR of the UWB signal data using a decluttering technique;
generate a magnitude and a phase of the UWB signal data using a transformation technique on the decluttered CIR;
unwrap the phase of the UWB signal data; and
remove at least one spurious peak in the magnitude and the unwrapped phase of the UWB signal data using a cell-average constant false alarm rate (CA-CFAR) detection technique.

18. The electronic device of claim 17, wherein the instructions, when executed by the one or more processors individually or collectively, further cause the electronic device to:
determine a temperature of the plurality of pre-configured UWB receivers.

19. The electronic device of claim 17, wherein the instructions, when executed by the one or more processors individually or collectively, further cause the electronic device to:
determine a phase difference of arrival (PDOA) between phases of the UWB signal data post the removal of at the least one spurious peak;
select a corresponding angle of arrival (AOA) that corresponds to the PDOA by comparing the PDOA with a stored correlation between known PDOA values and AOA values;
generate an AOA-adjusted UWB signal data by adjusting a field of view (FOV) of the plurality of pre-configured UWB receivers based on the corresponding AOA; and
combine the AOA-adjusted UWB signal data from each of the plurality of pre-configured UWB receivers prior to the training of the UWB encoder.

20. The electronic device of claim 15, wherein the instructions, when executed by the one or more processors individually or collectively, further cause the electronic device to:
determine, using a transformation technique, a plurality of frequencies of sounds in the audio data;
determine, using an extraction technique, a plurality of Mel-frequency cepstral coefficients (MFCC) based on the plurality of frequencies of sounds;
determine, using a spectral analysis technique, at least one qualitative feature of a reflected training audio data; and
extract the audio features by combining the plurality of MFCC with the at least one qualitative feature.
